(19) United States
(12) Patent Application Publication
(10) Pub. No.: US 2008/0020732 A1
(43) Pub. Date: Jan. 24, 2008

(54) SYSTEMS AND METHODS OF ADJUSTING FUNCTIONALITY OF A PORTABLE ELECTRONIC DEVICE

(75) Inventor: Chih-Hung Wu, Taipei City (TW)

Correspondence Address: THOMAS, KAYDEN, HORSTEMEYER & RISLEY LLP, 600 GALLERIA PARKWAY, 15TH FLOOR, ATLANTA, GA, 30339, US

(73) Assignee: TAIWAN SEMICONDUCTOR MANUFACTURING CO., LTD., Hsin-Chu (TW)

(21) Appl. No.: 11/457,481

(22) Filed: Jul. 14, 2006

(51) Int. Cl. G08B 5/22

(52) U.S. Cl. 455/411; 340/825.22; 340/7.41; 348/211.2; 455/556.2; 455/418; 455/419

(57) ABSTRACT

A system implementing functionality adjustment for a portable electronic device. A portable electronic device has an interface, a function module, and a controller. The interface communicates with a host. The function module provides functionality. The controller sends identification information of the portable electronic device to the host and receives a first command from the host via the interface, and disables the function module in response to the first command. The host provides a functionality setting specifying a prohibited function for the portable electronic device, receives identification information from the portable electronic device, and sends a first command to the portable electronic device via the interface, wherein the first command, when executed by the portable electronic device, causes prohibited function thereof to be disabled according to the functionality setting.

### BACKGROUND

The invention relates generally to portable electronic devices and wireless communication systems, and more particularly to a system and method for adjusting functionality of a portable electronic device.

Mobile phones are widely used, and are equipped with various functionalities. For example, mobile phones can be used to place telephone calls, take photographs, access the Internet, send and receive email, check stock quotes and sports scores, as well as operate as a personal digital assistant (or PDA) and/or MP3 player.

Mobile phones connect to a telephone network using a wireless connection. Because of their portability, users frequently carry mobile phones with them throughout the day. Accordingly, functions of the mobile phone are available to a user throughout the day.

The various functionalities of a mobile phone, however, may be problematic in some circumstances. For example, in a semiconductor fab, photography and/or videography are generally prohibited. It is, however, difficult for a fab manager to prohibit photography when a mobile phone is employed. Conventionally, a portable electronic device equipped with a camera, such as a mobile phone, may be confiscated while a user is in the fab. The confiscation, however, may give rise to complaints or other inconveniences.

### SUMMARY

The present invention provides a portable electronic device with an adjustable functionality. The portable electronic device comprises an interface, a function module, and a controller. The interface communicates with a host. The function module provides functionality. The controller sends identification information of the mobile phone to the host and receives a first command from the host via the interface, and disables the function module in response to the first command.

The host comprises an interface and a controller. The interface communicates with the portable electronic device. The controller provides a functionality setting specifying a prohibited function, receives identification information from the portable electronic device, and sends a first command to the portable electronic device via the interface. When the first command is executed by the portable electronic device, the prohibited function thereof is disabled according to the setting.

In a functionality adjusting method for a portable electronic device, a functionality setting, specifying a prohibited function for the portable electronic device, is provided. Identification information of the portable electronic device is then received. A first command is sent to the portable electronic device, wherein the first command, when executed by the portable electronic device, causes the prohibited function thereof to be disabled according to the functionality setting. The prohibited function of the portable electronic device is disabled according to the first command.

The method may take the form of program code embodied in a tangible media. When the program code is loaded into and executed by a machine, the machine becomes an apparatus for practicing the method.

### DESCRIPTION OF THE DRAWINGS

The invention can be more fully understood by reading the subsequent detailed description and examples with references made to the accompanying drawings, wherein:

FIG. 1 is a schematic view of an embodiment of a system implementing functionality adjustment for a portable electronic device; and

FIG. 2 is a flowchart of an embodiment of a method of functionality adjustment for a portable electronic device.

### DETAILED DESCRIPTION

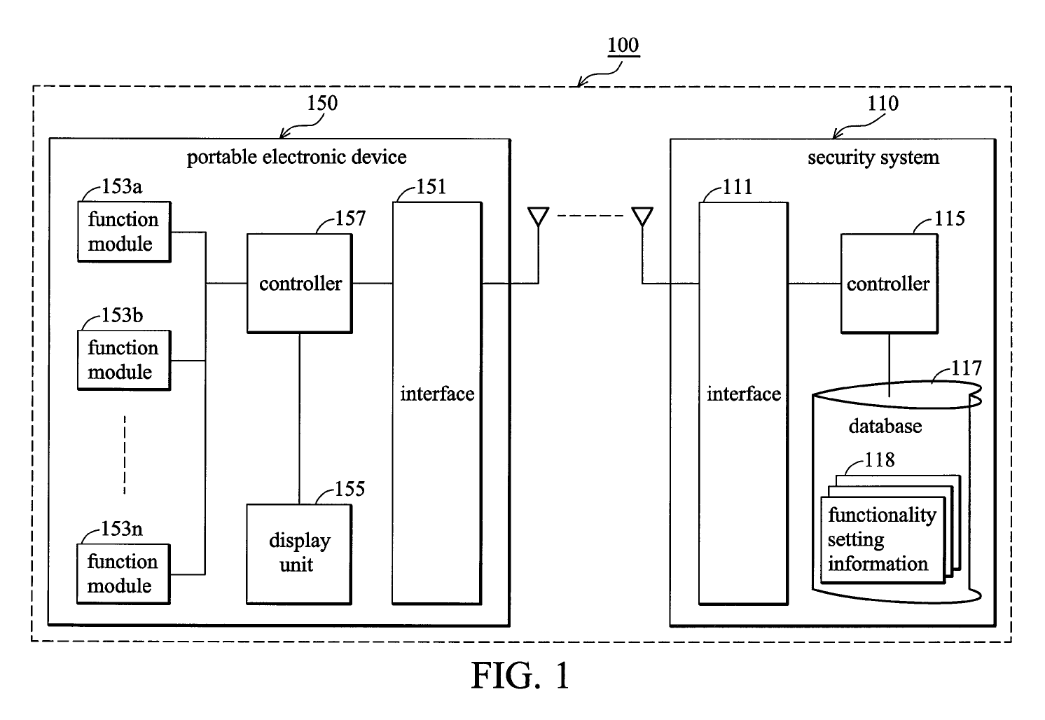

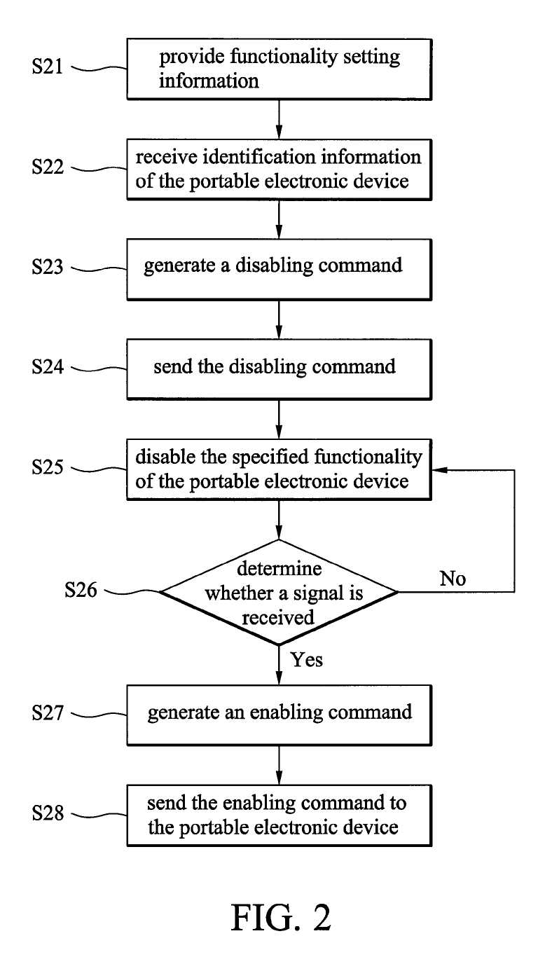

Exemplary embodiments of the invention will now be described with reference to FIGS. 1 and 2, which generally relate to functionality adjustment for a portable electronic device. While some embodiments of the invention are applicable to a mobile phone, it is understood that other portable electronic devices capable of wireless communication may be implemented.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic view of an embodiment of a system implementing functionality adjustment for a portable electronic device. Specifically, a system 100 comprises a security system 110 and a portable electronic device 150.

The portable electronic device 150 communicates with a remote security system 110 via a wireless connection. The portable electronic device 150 may be a mobile phone, personal digital assistant (PDA), or other portable electronic device capable of performing wireless communication. The portable electronic device 150 comprises an interface 151, function modules 153a˜153n, a display unit 155, and a controller 157. The interface 151 communicates with the security system 110. The function modules 153a˜153n each provides a different functionality from another. For example, function module 153a provides a photography function, function module 153b provides a recording function, and function module 153c provides an e-mail function. The controller 157 sends identification information to the security system 110, receives a disable command from the security system 110 via the interface 151, and disables at least one of the function modules 153a˜153n accordingly. The display unit 155 presents audio or visual signals to a user in response to a command given by the controller 157. When the portable electronic device 150 exits the coverage area of communication system 100, the controller 157 sends a signal to the security system 110, indicating that the portable electronic device 150 has been disconnected from the communication system 100. The controller 157 then receives an enabling command from the security system 110, and enables the previously disabled function module.

The identification information of the portable electronic device 150 may vary for different device types. For example, when the portable electronic device 150 is a mobile phone, the identification information may be an electronic serial number (ESN) or a mobile identification number (MIN). In the exemplary embodiment, the ESN is a 32-bit binary number configured by the manufacturer, comprising a manufacturer code and a serial number. The ESN is typically programmed into the device memory, such as a read-only-memory (ROM). In the exemplary embodiment, the MIN is a 34-bit number derived from the 10-digit telephone number of the mobile phone, comprising MIN1, a 24-bit number corresponding to a 7-digit directory number of the mobile phone, and MIN2, a 10-bit number corresponding to a 3-digit area code of the mobile phone.

The security system 110 comprises an interface 111, a controller 115, and a database 117. The interface 111 communicates with the portable electronic device 110 via a wireless connection, such as a wireless local area network (LAN) a Bluetooth connection, and a RF connection. The controller 115 provides functionality setting information 118 in advance, specifying a prohibited function for a particular portable electronic device. The functionality setting information may be stored in the database 117 together with identification information of the portable electronic device. When the controller 115 receives identification information from the portable electronic device 150, it sends a disable command to the portable electronic device 150 via the interface 111, wherein the disable command, when executed by the portable electronic device 150, disables the prohibited function of the portable electronic device 150 to the functionality setting information 118.

Here, the “prohibited function” may be configured to meet special requirements. For example, recording and photographic functionalities of a mobile phone may be set as prohibited function in a confidential situation, such as in a semiconductor fab.

FIG. 2 is a flowchart of an embodiment of a method of functionality adjustment for a portable electronic device. Functionality setting information specifying a prohibited function for a portable electronic device is provided in advance in step S21. The functionality setting information specifies a prohibited function for the portable electronic device, such as a mobile phone and personal digital assistant. Here, the “prohibited function” may be configured to meet special requirements. For example, recording or photographic functionalities of a mobile phone may be set as prohibited functions in a confidential situation, such as in a semiconductor fab.

When a portable electronic device connects to the communication system 100 (as shown in FIG. 1), identification information thereof is sent to the security system 110. The identification information is then received by the security system (step S22). The identification information of the portable electronic device may differ according to device type. Here, for a mobile phone, the identification information may be an electronic serial number (ESN) or a mobile identification number (MIN).

A disable command is generated according to the functionality setting (step S23). The disable command is then sent to the portable electronic device (step S24), wherein the disable command, when executed by the portable electronic device, disables the prohibited function accordingly (step S25).

It is then determined whether a signal, confirming that the prohibited functionality of the portable electronic device is disconnected from the communication system (step S26) has been received, and if so, the method proceeds to step S27, otherwise the method returns to step S25.

In step S27, an enabling command is generated, wherein the enabling command, when executed, enables the prohibited function.

In step S28, the enabling command is sent to the portable electronic device, enabling the corresponding function.

Various embodiments, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. Some embodiments may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing embodiments of the invention. When implemented on a general-purpose processor, the program code combines with the processor to provide a unique apparatus that operates analogously to specific logic circuits.

While the invention has been described by way of example and in terms of several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of adjusting functionality of a portable electronic device, comprising:
providing a functionality setting specifying a prohibited function for the portable electronic device;
receiving identification information of the portable electronic device;
sending a first command to the portable electronic device; and
disabling the prohibited function of the portable electronic device according to the first command.

2. The method of claim 1, wherein the functionality setting specifies a prohibited function for a mobile phone or personal digital assistant.

3. The method of claim 1, wherein the prohibited function is a photographic function.

4. The method of claim 1, wherein the prohibited function is an e-mail function.

5. The method of claim 1, wherein the prohibited function is a recording function.

6. The method of claim 1, wherein the identification information and the first command are transmitted over a wireless connection.

7. The method of claim 1, further comprising sending a second command to the portable electronic device, which, when executed by the portable electronic device, enables the prohibited functionality.

8. A portable electronic device, comprising:
a function module for providing a functionality for said portable device;
an interface for communicating with a host; and
a controller for sending identification information of said portable device to the host, receiving a first command from the host via the interface, and executing the first command to disable the function module.

9. The portable electronic device of claim 8, wherein the portable electronic device is a mobile phone or personal digital assistant.

10. The portable electronic device of claim 8, wherein the function module is a photographic function.

11. The portable electronic device of claim 8, wherein the function module is an e-mail function.

12. The portable electronic device of claim 8, wherein the function module is a recording function.

13. The portable electronic device of claim 8, wherein the interface transmits identification information and the first command over a wireless connection.

14. The portable electronic device of claim 8, wherein the controller further receives and executes a second command which causes the controller to enable the disabled function module.

15. A security control host system, comprising:
an interface for communicating with a remote electronic device; and
a controller for providing a functionality setting specifying a prohibited function of the remote electronic device, receiving identification information of the remote electronic device and sending a first command to the remote electronic device via the interface, wherein the first command, when executed by the remote electronic device, disables the prohibited function in the remote device according to the functionality setting.

16. The system of claim 15, wherein the prohibited function is a photographic function.

17. The system of claim 15, wherein the prohibited function is an e-mail function.

18. The system of claim 15, wherein the prohibited function is a recording function.

19. The system of claim 15, wherein the controller further sends a second command to enable the prohibited function of the portable electronic device.

20. A security system, comprising a host and a portable electronic device, wherein:
the host comprises:
a host interface for communicating with the portable electronic device; and
a host controller for providing a functionality setting specifying a prohibited function of the portable electronic device, receiving identification information of the portable electronic device and sending a first command to the portable electronic device via the host interface, wherein the first command, when executed by the portable electronic device, disables the prohibited function in the remote device according to the functionality setting; and
the portable electronic device comprises:
a function module for providing a functionality for said portable electronic device;
a device interface for communicating with the host; and
a device controller for sending identification information of said portable electronic device to the host, receiving a first command from the host via the interface, and executing the first command to disable the function module.
